(19) United States
(12) Patent Application Publication
(10) Pub. No.: US 2013/0150021 A1
(43) Pub. Date: Jun. 13, 2013

(54) FEMTO BASE STATION GATEWAY AND OPERATING METHOD OF FEMTO BASE STATION GATEWAY

(71) Applicants: Sang Chul OH, Daejeon (KR); Byung-Han RYU, Daejeon (KR)

(72) Inventors: Sang Chul OH, Daejeon (KR); Byung-Han RYU, Daejeon (KR)

(73) Assignee: Electronics and Telecommunications Research Institute, Daejeon (KR)

(21) Appl. No.: 13/555,713

(22) Filed: Jul. 23, 2012

(30) Foreign Application Priority Data
Dec. 8, 2011 (KR) 10-2011-0131097

(51) Int. Cl. H04W 88/16; H04W 92/20

(52) U.S. Cl. 455/422.1; 455/561

(57) ABSTRACT

Disclosed is a femto base station gateway which includes an X2 interface configured to perform X2 communication; an S1 interface configured to perform S1 communication; and an X2 cache configured to store an X2 response message received via the X2 interface.

### CROSS-REFERENCE TO RELATED APPLICATIONS

A claim for priority under 35 U.S.C. §119 is made to Korean Patent Application No. 10-2011-0131097 filed Dec. 8, 2011, in the Korean Intellectual Property Office, the entire contents of which are hereby incorporated by reference.

### BACKGROUND

The inventive concepts described herein relate to wireless communication, and more particularly, relate to a femto base station gateway and an operating method of the femto base station gateway.

A wireless mobile network may provide a seamless wireless communication service to a wireless communication terminal having mobility. The wireless mobile network may be formed of a plurality of stations.

Each base station may operate one cell. A base station may perform wireless communication with a wireless communication terminal placed within a corresponding cell. When a wireless communication terminal moves from one cell (e.g., a source cell) into another cell (e.g., a target cell), a base station of the target cell may establish communication with a wireless communication terminal, and a base station of the source cell may terminate communication with the wireless communication terminal. This operation may be referred to as a handover (HO). The handover may enable the wireless mobile network to provide a seamless wireless communication service to a wireless communication terminal.

Commercialized wireless mobile networks may include GSM (Global System for Mobile communication), CDMA (Code Division Multiple Access), WCDMA (Wideband CDMA), CDMA 2000, WiMAX (World interoperability for Microwave Access), LTE (Long Term Evolution), and the like.

The wireless mobile network may be a heterogeneous network which includes different sizes of cells. The heterogeneous network may include a macro cell, micro cell, pico cell, femto cell, and the like according to a cell size.

Macro cells and micro cells may form a basic cell structure. Pico cells and femto cells may be installed to further cover a shadow region or a region that the density of the user equipment is high, within the basic cell structure formed by the macro cells.

A base station forming a macro cell or a micro cell may be referred to as an eNB (evolved Node B). A base station forming a pico cell and a femto cell may be installed within a building, and may be referred to as a HeNB (Home evolved Node B).

### SUMMARY

Example embodiments of the inventive concept provide a femto base station gateway comprising an X2 interface configured to perform X2 communication; an S1 interface configured to perform S1 communication; and an X2 cache configured to store an X2 response message received via the X2 interface.

In example embodiments, when an X2 request message is received via the X2 interface and an X2 response message corresponding to the X2 request message is stored at the X2 cache, the X2 interface is configured to transmit the X2 response message stored at the X2 cache.

In example embodiments, when an X2 request message is received via the X2 interface and an X2 response message corresponding to the X2 request message is not stored at the X2 cache, the X2 interface is configured to relay the X2 request message to a target base station of the X2 request message and to relay an X2 response message received from the target base station to a source base station of the X2 request message.

In example embodiments, the X2 cache is configured to store the relayed X2 response message.

In example embodiments, the X2 request message and the X2 response message are relayed between a macro base station and a femto base station.

In example embodiments, the X2 cache is configured to store information of a target base station, an X2 request message to the target base station, and an X2 response message from the target base station.

Example embodiments of the inventive concept also provide an operating method of a femto base station gateway which is configure to perform S1 communication with a mobility management entity, X2 communication with a macro base station, and S1 and X2 communication with a femto base station. The operating method comprises receiving an X2 request message; and transmitting a response message stored at an X2 cache in response to the X2 request message when the response message corresponding to the X2 request message is stored at the X2 cache.

In example embodiments, the operating method further comprises sending the X2 request message to a target base station when the response message corresponding to the X2 request message is not stored at the X2 cache; receiving an X2 response message from the target base station; and sending the X2 response message.

In example embodiments, the X2 response message received from the target base station is stored at the X2 cache.

Example embodiments of the inventive concept also provide an operating method of a femto base station gateway which is configure to perform S1 communication with a mobility management entity, X2 communication with a macro base station, and S1 and X2 communication with a femto base station. The operating method comprises relaying an X2 request message and an X2 response message between the macro base station and the femto base station; storing the relayed X2 response message; and when the X2 request message is re-received, sending the stored X2 response message to a source base station of the re-received X2 request message.

### BRIEF DESCRIPTION OF THE FIGURES

The above and other objects and features will become apparent from the following description with reference to the following figures, wherein like reference numerals refer to like parts throughout the various figures unless otherwise specified, and wherein

FIG. 1 is a conceptual diagram schematically illustrating a cellular network according to an embodiment of the inventive concept.

FIG. 2 is a conceptual diagram schematically illustrating a wireless communication network including a cellular network in FIG. 1.

FIG. 3 is a block diagram schematically illustrating a femto base station gateway according to an embodiment of the inventive concept.

FIG. 4 is a flowchart illustrating an operating method of a femto base station gateway in FIG. 3.

FIG. 5 is a flowchart illustrating an X2 message relaying and caching operation of a femto base station gateway according to an embodiment of the inventive concept.

FIG. 6 is a flowchart illustrating an X2 message relaying and caching operation of a femto base station gateway according to another embodiment of the inventive concept.

FIG. 7 is a flowchart illustrating an X2 message relaying and caching operation of a femto base station gateway according to still another embodiment of the inventive concept.

FIG. 8 is a table illustrating data managed by an X2 cache.

### DETAILED DESCRIPTION

Embodiments will be described in detail with reference to the accompanying drawings. The inventive concept, however, may be embodied in various different forms, and should not be construed as being limited only to the illustrated embodiments. Rather, these embodiments are provided as examples so that this disclosure will be thorough and complete, and will fully convey the concept of the inventive concept to those skilled in the art. Accordingly, known processes, elements, and techniques are not described with respect to some of the embodiments of the inventive concept. Unless otherwise noted, like reference numerals denote like elements throughout the attached drawings and written description, and thus descriptions will not be repeated. In the drawings, the sizes and relative sizes of layers and regions may be exaggerated for clarity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Also, the term “exemplary” is intended to refer to an example or illustration.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

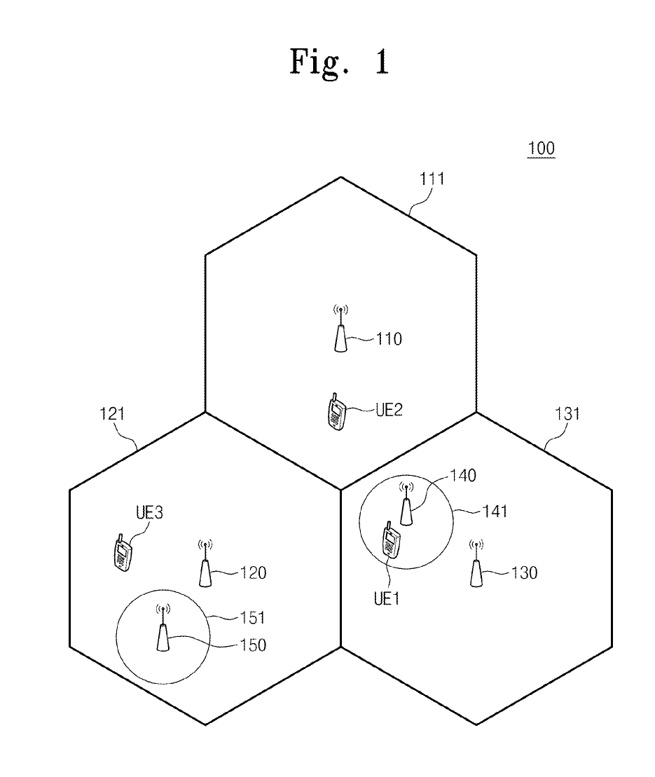

FIG. 1 is a conceptual diagram schematically illustrating a cellular network according to an embodiment of the inventive concept. Referring to FIG. 1, a cellular network 100 may include macro base stations 110, 120, and 130 and femto base stations 140 and 150. The macro base stations 110, 120, and 130 and the femto base stations 140 and 150 may perform wireless communication with plural user equipment UE1, UE2, and UE3.

The macro base stations 110, 120, and 130 may form macro cells 111, 121, and 131, respectively. The femto base stations 140 and 150 may form femto cells 141 and 151, respectively. Sizes of the macro cells 111, 121, and 131 may be larger than sizes of the femto cells 141 and 151.

The macro cells 111, 121, and 131 may form a basic cell structure of the cellular network 100. The femto cell 141 and 151 may cover a shadow region or a region that the density of the user equipment is high, within the basic cell structure formed by the macro cells 111, 121, and 131. The macro base stations 110, 120, and 130 forming macro cells 111, 121, and 131 may be referred to as an eNB (evolved Node B). The femto base stations 140 and 150 forming femto cells 141 and 151 may be referred to as a HeNB (Home evolved Node B).

The cellular network 100 may include different sizes of cells. That is, the cellular network 100 may be a heterogeneous network.

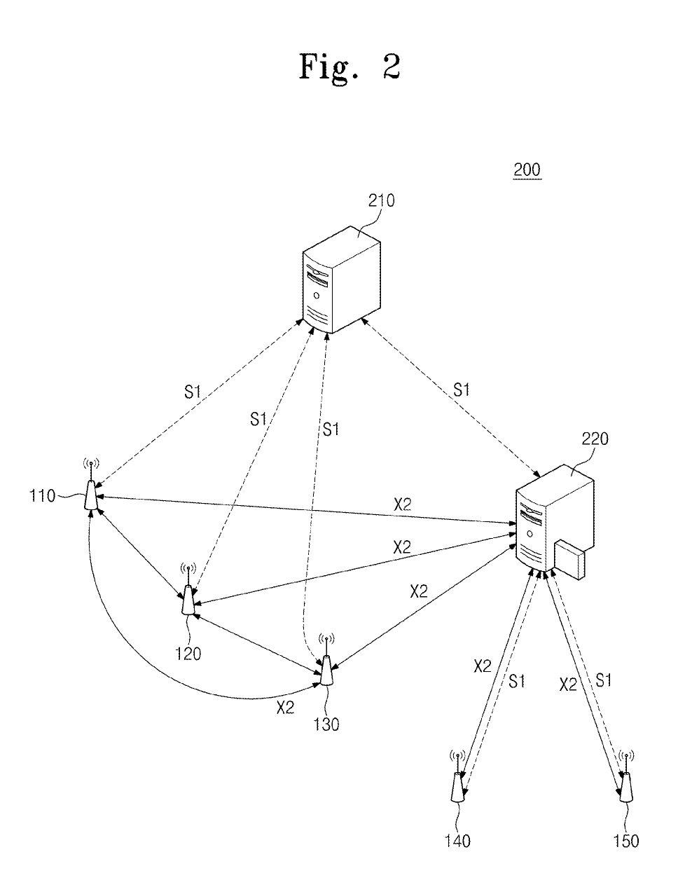

FIG. 2 is a conceptual diagram schematically illustrating a wireless communication network including a cellular network in FIG. 1. Referring to FIGS. 1 and 2, a wireless communication network 200 may include a mobility management entity (MME) 210, a femto base station gateway 220, macro base stations 110, 120, and 130, and femto base stations 140 and 150. For easy of illustration, cells 111, 121, 131, 141, and 151 in FIG. 1 are not illustrated in FIG. 2.

The mobility management entity 210 may be configured to control the wireless communication network 200 and wireless communication between the wireless communication network 200 and plural user equipment UE1, UE2, and UE3.

The macro base stations 110, 120, and 130 may perform communication with the mobility management entity 210 through an S1 interface. The macro base stations 110, 120, and 130 may perform mutual communication through an X2 interface.

The femto base stations 140 and 150 may perform communication with the femto base station gateway 220 through the X2 interface and the S1 interface. The femto base station gateway 220 may perform communication with the macro base stations 110, 120, and 130 through the X2 interface.

The S1 interface may be used to send a message for controlling the base stations 110, 120, 130, 140, and 150 and messages for controlling the user equipment UE1, UE2, and UE3 communicating with the base stations 110, 120, 130, 140, and 150. The S1 interface may connect the base stations 110, 120, 130, 140, and 150 with the mobility management entity 210 being an upper layer.

The X2 interface may be used to send a message for performing a handover between the macro base stations 110, 120, and 130 or preventing interference therebetween. The macro base stations 110, 120, and 130 may perform mutual communication through the X2 interface to determine handover points of time of the user equipment UE1, UE2, and UE3. When the macro base stations 110, 120, and 130 use the same carrier wave, they may perform mutual communication through the X2 interface to share a wireless resource. This may enable interference between the user equipment UE1, UE2, and UE3 to be prevented or minimized.

The femto base stations 140 and 150 may be connected with the X2 interface through the femto base station gateway 220. The femto base station gateway 220 may relay X2 messages to be transferred between the femto base stations 140 and 150.

The X2 interface may be used to send a message for performing a handover between the femto base stations 140 and 150 or preventing interference therebetween. The femto base stations 140 and 150 may perform mutual communication through the X2 interface under a relay of the femto base station gateway 220 to determine handover points of time of the user equipment UE1, UE2, and UE3. When the femto base stations 140 and 150 use the same carrier wave, they may perform mutual communication through the X2 interface under a relay of the femto base station gateway 220 to share a wireless resource. This may enable interference between the user equipment UE1, UE2, and UE3 to be prevented or minimized.

The handover HO and interference may be generated between macro base stations 110, 120, and 130, between the femto base stations 140 and 150, and between the macro base stations 110 to 130 and the femto base stations 140 and 150. The femto base station gateway 220 may relay the X2 message between the macro base stations 110 to 130 and the femto base stations 140 and 150. The femto base station gateway 220 may transmit the X2 message from the macro base stations 110 to 130 to the femto base stations 140 and 150, and may transmit the X2 message from the femto base stations 140 and 150 to the macro base stations 110 to 130.

The macro base stations 110 to 130 and the femto base stations 140 and 150 may perform mutual communication through the X2 interface under a relay of the femto base station gateway 220 to perform a handover and prevent interference.

The macro base stations 110 to 130 may perform direct communication through the X2 interface. On the other hand, the femto base stations 140 and 150 may communicate by the X2 interface through the femto base station gateway 220. The macro base stations 110 to 130 and the femto base stations 140 and 150 may communicate by the X2 interface through the femto base station gateway 220. A time delay may arise when the femto base station gateway 220 intervenes in communication between macro base stations 110 to 130. The time delay may cause a handover timing error, so that the quality of service QoS provided to the user equipment UE1 and UE2 is lowered.

To prevent a time delay due to a relay of the femto base station gateway 220, the femto base station gateway 220 may have an X2 cache function where a relayed X2 message is stored and the stored X2 message is sent instead of the base stations 110 to 150.

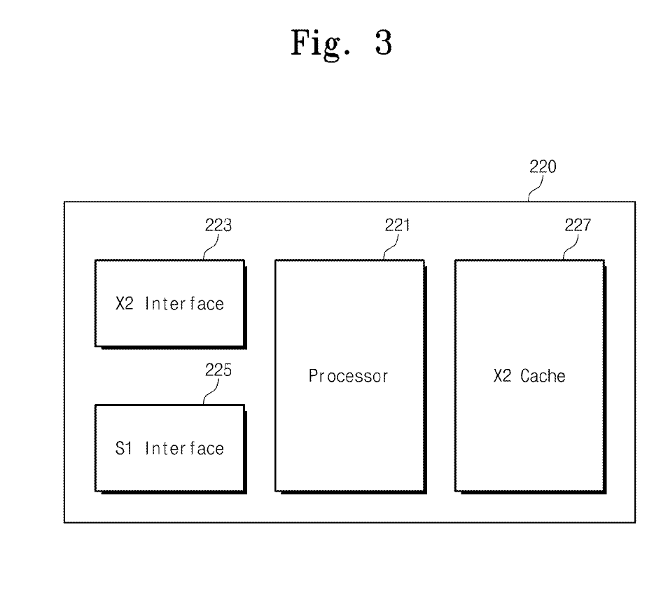

FIG. 3 is a block diagram schematically illustrating a femto base station gateway according to an embodiment of the inventive concept. Referring to FIGS. 2 and 3, a femto base station gateway 220 may include a processor 221, an X2 interface 223, an S1 interface 225, and an X2 cache 227.

The processor 221 may be configured to the X2 interface 223, the S1 interface 225, and the X2 cache 227.

The X2 interface 223 may perform X2 interface based communication. The X2 interface 223 may perform X2 interface based communication with macro base stations 110, 120, and 130 and femto base stations 140 and 150.

The S1 interface 225 may perform S2 interface based communication. The S2 interface 225 may perform S2 interface based communication with the femto base stations 140 and 150 and a mobility management entity (MME) 210.

The X2 cache 227 may be configured to store an X2 message transmitted or received through the X2 interface 223.

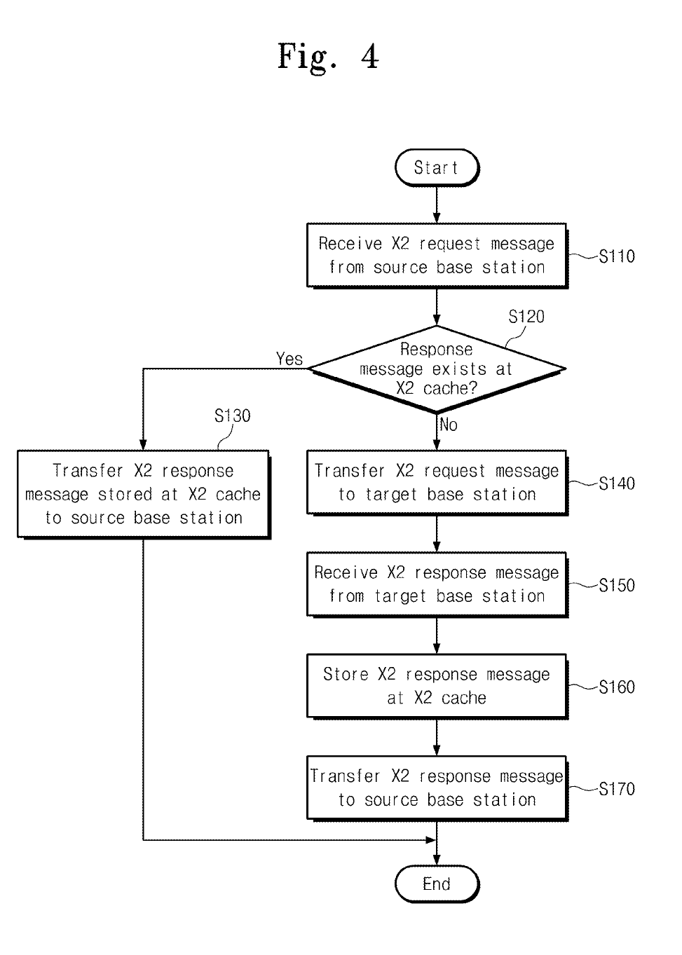

FIG. 4 is a flowchart illustrating an operating method of a femto base station gateway in FIG. 3. Referring to FIGS. 2 to 4, in operation S110, a femto base station gateway 220 may receive an X2 request message from a source base station. The source base station may be one generating and transmitting the X2 request message from among macro base stations 110, 120, and 130 and femto base stations 140 and 150.

In operation S120, the femto base station gateway 220 may judge whether a response message exists at an X2 cache 227. The femto base station gateway 220 may judge whether an X2 response message to the input X2 request message exists at the X2 cache 227.

The X2 request message may include information of a base station as a target of the X2 request message. The femto base station gateway 220 may judge whether an X2 response message corresponding to the X2 request message and transmitted from a target base station is stored at the X2 cache 227.

In a case where the X2 response message is stored at the X2 cache 227, in operation S130, the femto base station gateway 220 may transmit the X2 response message stored at the X2 cache 227 to the source base station.

In a case where the X2 response message is not stored at the X2 cache 227, in operation S140, the femto base station gateway 220 may send the input X2 request message to the target base station. In operation S150, the femto base station gateway 220 may receive the X2 response message to the X2 request message from the target base station.

In operation S160, the femto base station gateway 220 may store the input X2 response message at the X2 cache 227. At this time, the input X2 request message may be stored at the X2 cache 227 with the X2 response message.

In operation S170, the femto base station gateway 220 may transmit the input X2 response message to the source base station.

As described above, when an X2 response message to an X2 request message is not stored at the X2 cache 227, the femto base station gateway 220 may relay the X2 request message. If an X2 response message is received from a target base station, the femto base station gateway 220 may relay the X2 response message, and may store the relayed X2 response message at the X2 cache 227. Afterwards, if the same X2 request message on the same target base station is received, the femto base station gateway 220 may not relay the X2 request message and X2 response message. The femto base station gateway 220 may send an X2 response message stored at the X2 cache 227 to a source base station instead of a target base station.

With the X2 cache 227, it is possible to shorten a time taken for the femto base station gateway 220 to relay an X2 message. Thus, it is possible to improve a communication speed.

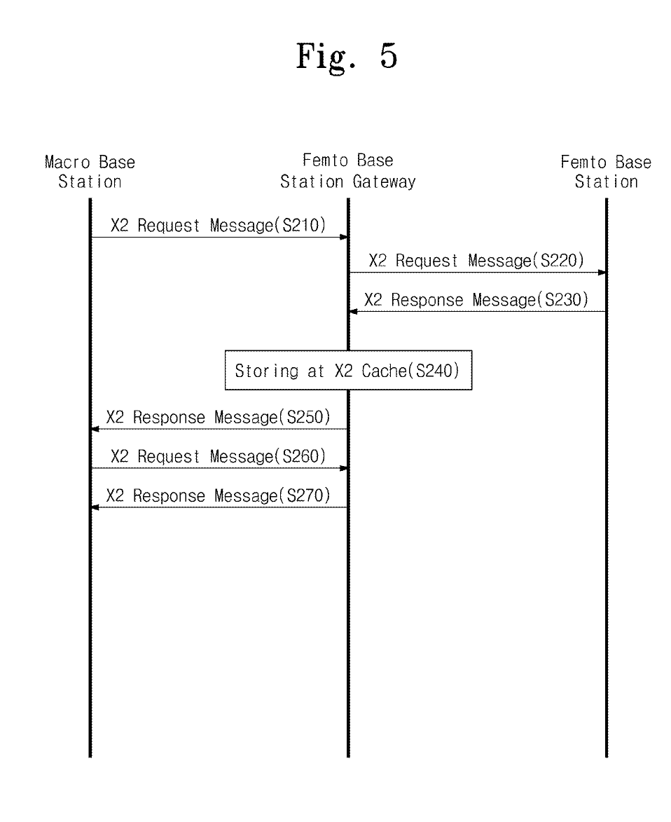

FIG. 5 is a flowchart illustrating an X2 message relaying and caching operation of a femto base station gateway according to an embodiment of the inventive concept. Referring to FIGS. 2, 3, and 5, a femto base station gateway 220 may relay and cache an X2 message between one of macro base stations 110, 120, and 130 and one of femto base stations 140 and 150.

In operation S210, a macro base station may send an X2 request message to a femto base station as a target base station. The X2 request message may be transferred to the femto base station gateway 220. It is assumed that an X2 response message to the X2 request message is not stored at an X2 cache 227. In operation S220, the femto base station gateway 220 may relay the X2 request message to the femto base station. In operation S230, the femto base station may transmit an X2 response message to X2 request message to the femto base station gateway 220. In operation S240, the femto base station gateway 220 may store the X2 response message at the X2 cache 227. In operation S250, the femto base station gateway 220 may relay the X2 response message to a macro base station being a source base station.

Afterwards, in operation S260, if the same X2 request message to be sent to the same femto base station being a target base station is received, in operation S270, the femto base station gateway 220 may not relay the X2 request message, but immediately send an X2 response message stored at the X2 cache 227 to a macro base station. At this time, the femto base station gateway 220 may immediately send an X2 response message stored at the X2 cache 227 if a target base station and an X2 request message are matched with information stored at the X2 cache 227 regardless of a source base station.

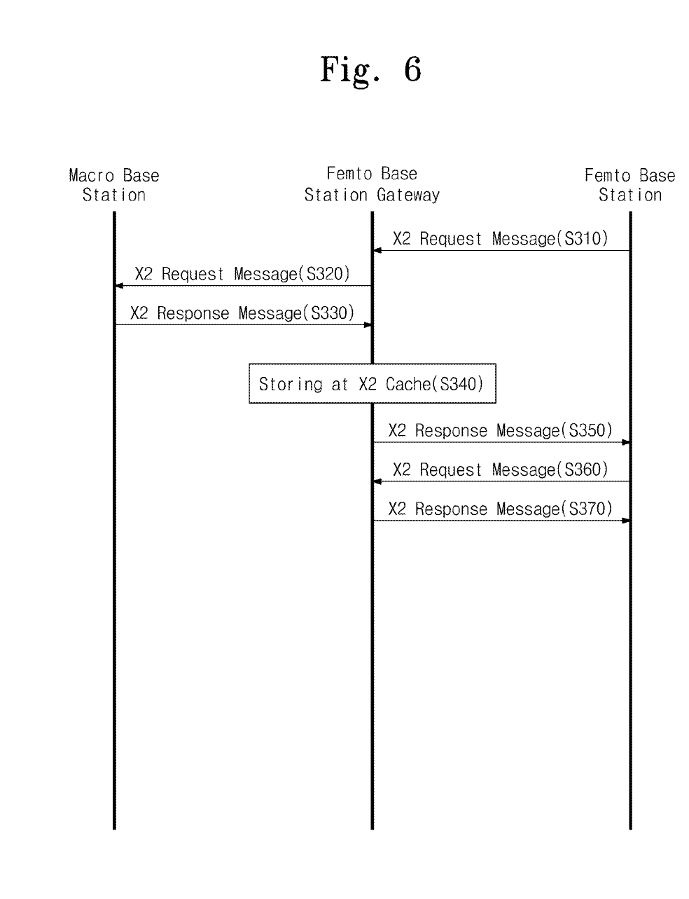

FIG. 6 is a flowchart illustrating an X2 message relaying and caching operation of a femto base station gateway according to another embodiment of the inventive concept. Referring to FIGS. 2, 3, and 6, a femto base station gateway 220 may relay and cache an X2 message between one of macro base stations 110, 120, and 130 and one of femto base stations 140 and 150.

The X2 message relaying and caching method in FIG. 6 may be substantially the same as that described in FIG. 5 except that a source base station is a femto base station and a target base station is a macro base station, and description thereof is thus omitted.

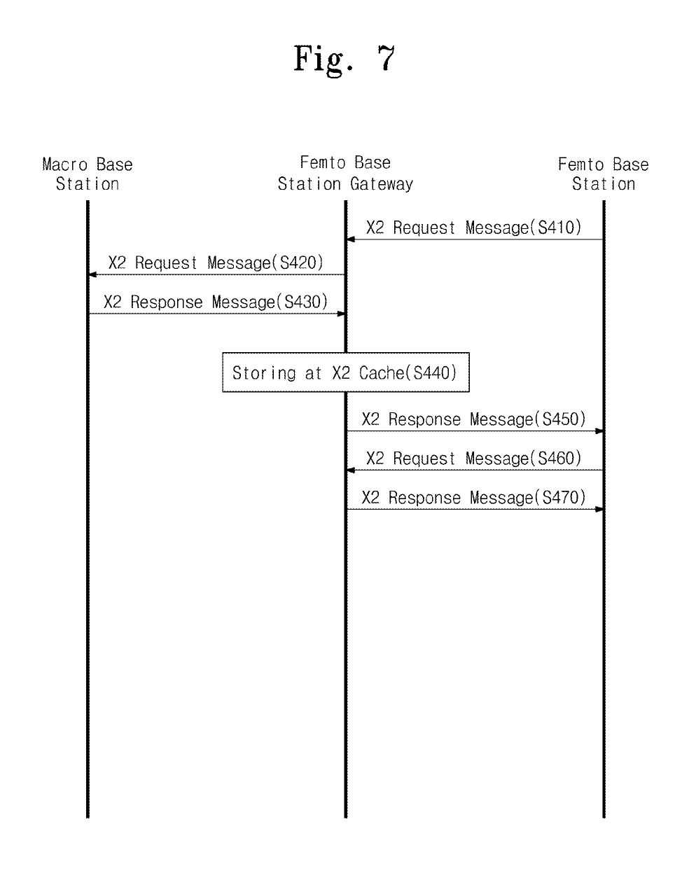

FIG. 7 is a flowchart illustrating an X2 message relaying and caching operation of a femto base station gateway according to still another embodiment of the inventive concept. Referring to FIGS. 2, 3, and 7, a femto base station gateway 220 may relay and cache an X2 message between two ones of femto base stations 140 and 150.

The X2 message relaying and caching method in FIG. 7 may be substantially the same as that described in FIG. 5 except that a source base station and a target base station are femto base stations, and description thereof is thus omitted.

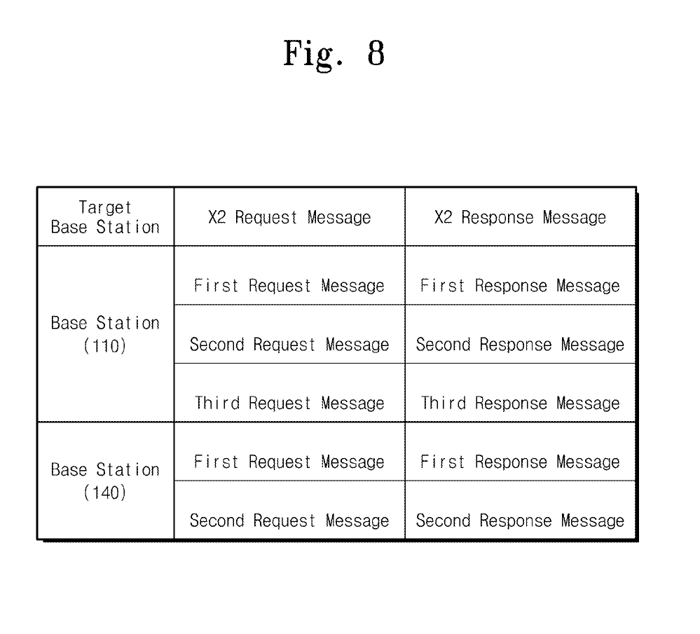

FIG. 8 is a table illustrating data managed by an X2 cache. Referring to FIGS. 3 and 8, an X2 cache 227 may store a target base station, an X2 request message, and an X2 response message.

When receiving an X2 request message, a femto base station gateway 220 may immediately transmit an X2 response message when types of a target base station and an X2 request message are matched with information stored at an X2 cache 227.

In example embodiments, the femto base station gateway 220 may cache an X2 response message according to an X2 request message received from a macro base station, and may immediately transmit the cached X2 response message according to an X2 request message received from a femto base station. The femto base station gateway 220 may cache an X2 response message according to an X2 request message received from a femto base station, and may immediately transmit the cached X2 response message according to an X2 request message received from a macro base station. The femto base station gateway 220 may immediately transmit an X2 response message when a target base station and an X2 request message are matched with items stored at an X2 cache 227 regardless of a source bases station type.

While the inventive concept has been described with reference to exemplary embodiments, it will be apparent to those skilled in the art that various changes and modifications may be made without departing from the spirit and scope of the present invention. Therefore, it should be understood that the above embodiments are not limiting, but illustrative.

What is claimed is:

1. A femto base station gateway comprising:
an X2 interface configured to perform X2 communication;
an S1 interface configured to perform S1 communication; and
an X2 cache configured to store an X2 response message received via the X2 interface.

2. The femto base station gateway of claim 1, wherein when an X2 request message is received via the X2 interface and an X2 response message corresponding to the X2 request message is stored at the X2 cache, the X2 interface is configured to transmit the X2 response message stored at the X2 cache.

3. The femto base station gateway of claim 1, wherein when an X2 request message is received via the X2 interface and an X2 response message corresponding to the X2 request message is not stored at the X2 cache, the X2 interface is configured to relay the X2 request message to a target base station of the X2 request message and to relay an X2 response message received from the target base station to a source base station of the X2 request message.

4. The femto base station gateway of claim 3, wherein the X2 cache is configured to store the relayed X2 response message.

5. The femto base station gateway of claim 3, wherein the X2 request message and the X2 response message are relayed between a macro base station and a femto base station.

6. The femto base station gateway of claim 1, wherein the X2 cache is configured to store information of a target base station, an X2 request message to the target base station, and an X2 response message from the target base station.

7. An operating method of a femto base station gateway which is configure to perform S1 communication with a mobility management entity, X2 communication with a macro base station, and S1 and X2 communication with a femto base station, the operating method comprising:
receiving an X2 request message; and
transmitting a response message stored at an X2 cache in response to the X2 request message when the response message corresponding to the X2 request message is stored at the X2 cache.

8. The operating method of claim 7, further comprising:
sending the X2 request message to a target base station when the response message corresponding to the X2 request message is not stored at the X2 cache;
receiving an X2 response message from the target base station; and
sending the X2 response message.

9. The operating method of claim 8, wherein the X2 response message received from the target base station is stored at the X2 cache.

10. An operating method of a femto base station gateway which is configure to perform S1 communication with a mobility management entity, X2 communication with a macro base station, and S1 and X2 communication with a femto base station, the operating method comprising:
relaying an X2 request message and an X2 response message between the macro base station and the femto base station;
storing the relayed X2 response message; and
when the X2 request message is re-received, sending the stored X2 response message to a source base station of the re-received X2 request message.
